(19) United States
(12) Patent Application Publication
(10) Pub. No.: US 2025/0383263 A1
(43) Pub. Date: Dec. 18, 2025

(54) METHODS AND SYSTEMS FOR DIAGNOSING DEFECTS IN WHEEL BEARINGS

(71) Applicants: HYUNDAI MOTOR COMPANY, Seoul (KR); KIA CORPORATION, Seoul (KR)

(72) Inventors: Dong Ho LEE, Hwaseong-si (KR); Gi Ryung JUNG, Hwaseong-si (KR); Yun Hee CHOI, Gwangmyeong-si (KR)

(73) Assignees: HYUNDAI MOTOR COMPANY, Seoul (KR); KIA CORPORATION, Seoul (KR)

(21) Appl. No.: 18/950,758

(22) Filed: Nov. 18, 2024

(30) Foreign Application Priority Data
Jun. 14, 2024 (KR) 10-2024-0077393

(51) Int. Cl. G01M 13/045

(52) U.S. Cl. CPC G01M 13/045

(57) ABSTRACT

A method for diagnosing a defect of a wheel bearing includes obtaining a vibration acceleration signal of a wheel of a vehicle including a wheel bearing, preprocessing the vibration acceleration signal, determining a first parameter and a second parameter from the preprocessed vibration acceleration signal, obtaining a reference parameter from the first parameter and the second parameter, and comparing the reference parameter with a preset upper limit value, determining that the wheel bearing is defective when the reference parameter exceeds the upper limit value, and determining that the wheel bearing is normal when the reference parameter is equal to or less than the upper limit value.

### CROSS-REFERENCE TO RELATED APPLICATION(S)

The present application claims priority to Korean Patent Application No. 10-2024-0077393 filed on Jun. 14, 2024, the entire contents of which is incorporated herein for all purposes by this reference.

### BACKGROUND OF THE PRESENT DISCLOSURE

### Field of the Present Disclosure

The present disclosure relates to a method and system for diagnosing a defect of a wheel bearing.

### Description of Related art

A wheel bearing is an essential component mounted in the center of a vehicle wheel axle to help smooth rotation, reducing driving resistance and increasing steering stability.

Wheel bearings may wear out or be damaged over time, and in the instant case, noise, vibrations, and safety issues may arise.

Therefore, it is necessary to determine whether a wheel bearing is defective and replace the parts thereof promptly. However, generally, whether to replace parts was determined using the results of acoustic measurements or the like during an operation of wheel bearings, without clear standards, in vehicle maintenance sites.

Therefore, there is a demand for a diagnostic technology which may objectively and accurately determine whether a wheel bearing is defective.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing objectively and accurately determining whether a wheel bearing is defective.

Another aspect of the present disclosure is to diagnose whether wheel bearings respectively mounted on wheels of a vehicle are defective without omission.

The present disclosure proposes a method and device for diagnosing a defect of a wheel bearing of a vehicle.

According to an aspect of the present disclosure, a method for diagnosing a defect of a wheel bearing includes: obtaining a vibration acceleration signal of a wheel of a vehicle including a wheel bearing; preprocessing the vibration acceleration signal; determining a first parameter and a second parameter from the preprocessed vibration acceleration signal; obtaining a reference parameter from the first parameter and the second parameter; and comparing the reference parameter with a preset upper limit value, determining that the wheel bearing is defective when the reference parameter exceeds the upper limit value, and determining that the wheel bearing is normal when the reference parameter is equal to or less than the upper limit value.

The method may further include: outputting a result of the determining.

The first parameter may be an average of vibration energy determined by integrating the vibration acceleration signal in a preset frequency band.

The second parameter may be an average of amplitude variations determined by differentiating the vibration acceleration signal in the preset frequency band.

The reference parameter may be a sum of the first parameter and the second parameter multiplied by a constant.

In the determining of the wheel bearing as being defective or normal, the first parameter of the wheel bearing determined as being defective may be greater than the first parameter of the wheel bearing determined as being normal.

In the determining of the wheel bearing as being defective or normal, the second parameter of the wheel bearing determined as being defective may be greater than the second parameter of the wheel bearing determined as being normal.

The determining of the first parameter and the second parameter may include determining the first parameter and the second parameter by performing at least one of differentiation and integration on the preprocessed vibration acceleration signal in a preset frequency band.

The preprocessing of the vibration acceleration signal may include: determining a three-axis (X, Y, Z) vector sum for the vibration acceleration signal; and performing a Fast Fourier Transform on the three-axis vector sum.

In the obtaining of the vibration acceleration signal of the wheel of the vehicle, when the vehicle mounted on a lift is driven and the wheel of the vehicle rotates, the vibration acceleration signal may be obtained through a sensor mounted on the wheel and connected to the processor.

The sensor may be mounted on an axle of the wheel and is removable.

Each of the operations may be performed sequentially for each wheel of the vehicle.

The wheel of the vehicle may include a first wheel and a second wheel, the wheel bearing may include a first wheel bearing mounted on the first wheel and a second wheel bearing mounted on the second wheel, and the sensor may measure a time required from a point in time at which whether the first wheel bearing is defective is determined to a point in time at which a vibration acceleration signal of the second wheel is obtained, and a vibration peak occurring within the required time period.

When the required time is less than a preset time or when a number of times a low-frequency band peak occurs as a result of measuring the vibration peak is less than a preset number of times, an alarm indicating that it is impossible to diagnose a defect of the second wheel may be output.

When the required time is greater than the preset time and the number of times the low-frequency band peak occurs as a result of measuring the vibration peak is greater than or equal to a preset number of times, each operation for diagnosing a defect of the second wheel bearing may be performed sequentially.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are diagrams schematically illustrating a mounting position of a sensor to diagnose a defect of a wheel bearing.

FIG. 2 is a conceptual diagram of a wheel bearing defect diagnosis system according to an exemplary embodiment of the present disclosure.

FIG. 3 is a flowchart of a wheel bearing defect diagnosis method according to an exemplary embodiment of the present disclosure.

FIG. 4 is a flowchart illustrating detailed operations of preprocessing a vibration acceleration signal.

FIG. 5 is a graph illustrating preprocessed vibration acceleration signals and a first parameter determined by integrating the same.

FIG. 6 is a graph illustrating preprocessed vibration acceleration signals and a second parameter determined by differentiating the same.

FIG. 7 is a graph illustrating a result of determining whether a wheel bearing is defective using a reference parameter.

FIG. 8 is a schematic diagram schematically illustrating an output unit outputting a defect determination result.

FIG. 9 is a graph illustrating a vibration acceleration signal when a sensor mounted on a first wheel is moved to be mounted on a second wheel.

FIG. 10 is a graph illustrating an example of a defect diagnosis failure alarm output to an output unit when a diagnosis omission is detected.

FIG. 11 is a graph of results when determining whether a wheel bearing is defective using only the number of times a vibration acceleration exceeds a threshold value.

FIG. 12 is a graph of results when determining whether a wheel bearing is defective using only the first parameter.

FIG. 13 is a graph of results when determining whether a wheel bearing is defective using first and second parameters according to a wheel bearing defect diagnosis method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

While the present disclosure may be modified in various ways and take on various alternative forms, specific embodiments thereof are shown in the drawings and described in detail below. However, it should be understood that there is no intent to limit the present disclosure to the forms disclosed, but on the other hand, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of at least one of the associated listed items.

The terms used herein to describe embodiments of the present disclosure are not intended to limit the scope of the present disclosure. The articles “a,” and “an” are singular in that they have a single referent, however the use of the singular form in the present specification should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, operations, operations, elements, and/or components but do not preclude the presence or addition of one or more other features, numbers, operations, operations, elements, components, and/or groups thereof.

Unless defined in a different manner, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed as having ideally or excessively formal meanings.

In the present specification, vehicles refer to a variety of vehicles that move transported objects, such as people, animals, or goods, from a starting point to a destination. These vehicles are not limited to vehicles that run on roads or tracks.

Hereinafter, various exemplary embodiments of the present disclosure will be described with reference to the accompanying drawings.

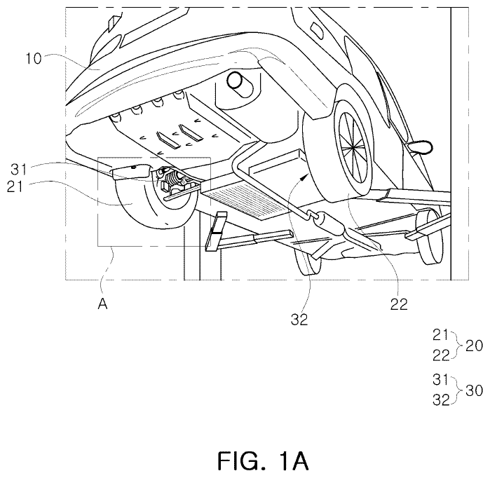

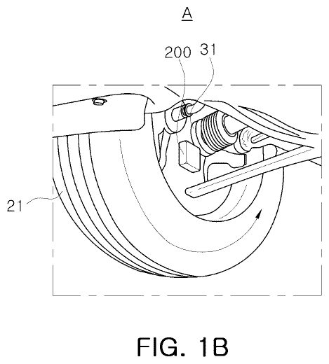

FIG. 1A and FIG. 1B are schematic diagrams illustrating a mounting location of a sensor for wheel bearing defect diagnosis.

Referring to FIG. 1A and FIG. 1B, a method for diagnosing a defect of a wheel bearing 30 according to an exemplary embodiment of the present disclosure may include determining a defect of the wheel bearing 30 by obtaining a vibration acceleration signal by a sensor 200 mounted on a wheel 20 of a vehicle 10, determining a reference parameter which may be objectified from the obtained vibration acceleration signal data, and comparing the reference parameter with an upper limit value.

Generally, whether the wheel bearing 30 is defective is determined based on the experience of a maintenance worker or based on simple acoustic measurement, leaving the possibility of problems, such as excessive maintenance occurring by determining a part within a normal range as being defect and replacing the part in question or determining a defective part as being normal. In contrast, the method for diagnosing a defect of a wheel bearing according to an exemplary embodiment of the present disclosure may solve the aforementioned problem by determining a first parameter Em and a second parameter Dm from the vibration acceleration signal data measured for each wheel 20 of the vehicle 10 and obtaining a reference parameter Z defined as the sum of the first parameter Em and a constant times of the second parameter Dm, and comparing the obtained reference parameter Z with a preset upper limit value to objectively determine whether the wheel bearing is defective.

When performing the method for diagnosing a defect of a wheel bearing according to an exemplary embodiment of the present disclosure, a vibration acceleration signal may be obtained by mounting the detachable sensor 200 on the wheel 20 of the vehicle 10 mounted on a lift and then rotating the wheel 20 by driving an engine. Here, a speed of the vehicle 10 is preferably maintained at a constant speed in the range of 50 km/h to 65 km/h, but is not limited thereto.

In an exemplary embodiment of the present disclosure, the wheel 20 of the vehicle 10 may include the wheel bearing 30. The wheel 20 may include a first wheel 21 and a second wheel 22, and the wheel bearing 30 may include a first wheel bearing 31 and a second wheel bearing 32. The first wheel bearing 31 may be provided on the first wheel 21, and the second wheel bearing 32 may be provided on the second wheel 22.

The detachable sensor 200 may be mounted on the first wheel 21 to measure a vibration acceleration signal of the first wheel bearing 31, and when it is determined whether the first wheel bearing 31 is defective according to the method for diagnosing a defect of a wheel bearing according to an exemplary embodiment of the present disclosure, the detachable sensor 200 may be moved to and mounted on the second wheel 22 to measure a vibration acceleration signal for determining whether the second wheel bearing 32 is defective. In the present manner, whether the wheel bearing 30 provided on each wheel 20 of the vehicle 10 is defective may be diagnosed using the single sensor 200.

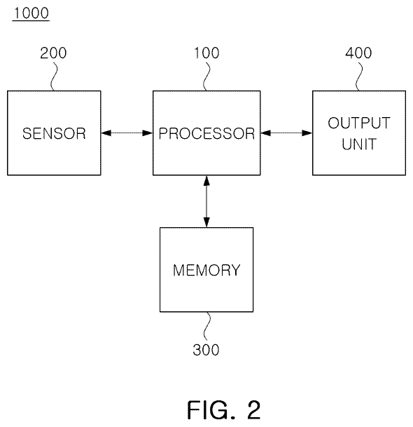

FIG. 2 is a conceptual diagram of a wheel bearing defect diagnosis system according to an exemplary embodiment of the present disclosure.

Referring to FIGS. 1A and 1B and FIG. 2, a wheel bearing defect diagnosis system 1000 of various exemplary embodiments of the present disclosure may include a processor 100, a sensor 200, a memory 300, and may further include an output unit 400.

The processor 100 may be connected to and control each of the sensor 200, the memory 300, and the output unit 400, and may perform a method for diagnosing a defect of a wheel bearing according to an exemplary embodiment of the present disclosure by executing a command stored in the memory 200.

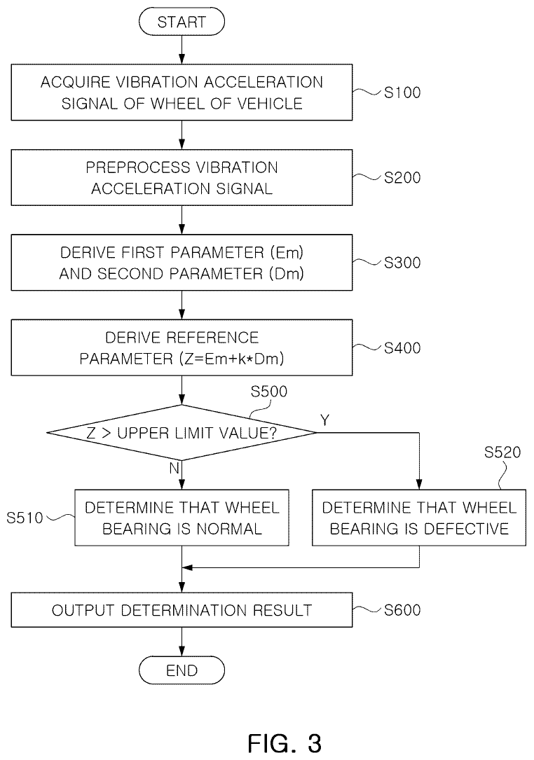

The processor 100 may obtain a vibration acceleration signal of the wheel 20 of the vehicle 10 measured by the sensor 200, preprocess the obtained vibration acceleration signal, and determine the first parameter Em and the second parameter Dm from the preprocessed vibration acceleration signal. Furthermore, the processor 100 may obtain the reference parameter Z from the determined first parameter Em and second parameter Dm, compare the reference parameter Z with a preset upper limit value, and determine that the wheel bearing 30 is defective if the reference parameter Z exceeds the upper limit value, and determine that the wheel bearing 30 is normal if the reference parameter Z is lower than the upper limit value. Meanwhile, the processor 100 may output the result of determining whether the wheel bearing 30 is defective through the output unit 400. A detailed algorithm for determining a defect of the wheel bearing 30 using the reference parameter Z is described below with reference to FIG. 3.

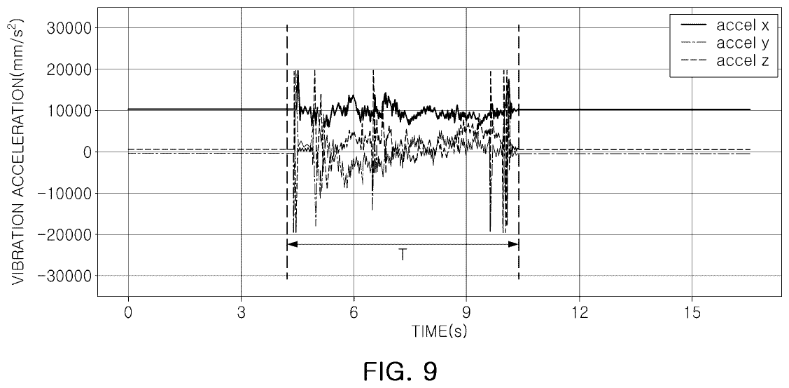

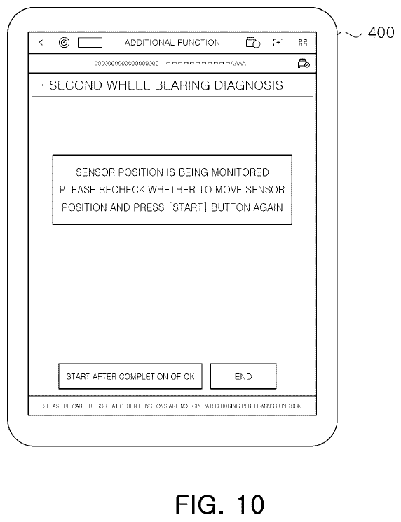

Furthermore, the processor 100 may monitor a time required for attaching and detaching the sensor 200 for each wheel 20 of the vehicle 10 and a vibration peak that occurs, determine whether a defect diagnosis for each wheel 20 is missed, and output an alarm to an operator. If the required time is less than a preset time (e.g., five seconds) or if the number of times a low-frequency band peak occurs as a result of measuring vibration peaks is less than a preset number of times (e.g., two times), the processor 100 may be configured to determine that the sensor 200 has not moved from the first wheel 21 to the second wheel 22, and output an alarm to the operator through the output unit 400 to indicate that it is impossible to diagnose a defect of the wheel bearing of the second wheel 22. Furthermore, if the required time is longer than or equal to the preset time (e.g., five seconds) and if the number of times the low-frequency band peak occurs as a result of measuring the vibration peaks is longer than or equal to the preset number of times (e.g., two times), the processor 100 may be configured to determine that the sensor 200 has moved from the first wheel 21 to the second wheel 22 and perform the method for diagnosing a defect of a wheel bearing for the second wheel 22. A detailed algorithm for determining whether a defect diagnosis is missing for each wheel 20 is described below with reference to FIG. 9 and FIG. 10.

The processor 100 of various exemplary embodiments of the present disclosure may be a semiconductor device that executes processing for instructions stored in a central processing unit (CPU) or a memory 200. The operations of the method or algorithm described in connection with the exemplary embodiments of the present disclosure may be directly implemented by hardware, a software module, or a combination of the two executed by the processor 100. The software module may reside in a storage medium, such as RAM memory, flash memory, ROM memory, EPROM memory, EEPROM memory, registers, a hard disk, a solid state drive (SSD), a removable disk, or a CD-ROM. For example, the storage medium may be coupled to the processor 100, and the processor 100 may read information from the storage medium and write information to the storage medium. Alternatively, the storage medium may be integral with the processor 100. The processor 100 and the storage medium may reside within an application-specific integrated circuit (ASIC). The ASIC may reside within a user terminal. Alternatively, the processor 100 and the storage medium may reside as separate components within the user terminal.

The sensor 200 is configured for measuring a vibration acceleration signal of the vehicle wheel 20 as a target of wheel bearing defect diagnosis. The sensor 200 of various exemplary embodiments of the present disclosure may be mounted on an axis of the vehicle wheel 20 including the wheel bearing 30 and may measure vibration acceleration signals of three axes (X-axis, Y-axis, and Z-axis) of forward/backward, left/right, and up/down directions under the control of the processor 100. Furthermore, the sensor 200 is detachable, so that the sensor 200 may be moved to be mounted on each wheel 20 of the vehicle 10 as a target of wheel bearing 30 defect diagnosis. Meanwhile, the individual vibration acceleration signals of each of the three axes (X-axis, Y-axis, and Z-axis) detected by the sensor 200 may be unified by the processor 100 into a three-axis vector sum (\sqrt{x²+y²+z²}), minimizing errors according to an attachment angle of the sensor 200.

The memory 300 may be connected to the processor 100 to be controlled by the processor 100 and may store commands executed by the processor 100 and vibration acceleration signal data of the vehicle wheel 20 measured by the sensor 200. The memory 300 of various exemplary embodiments of the present disclosure may include, but is not limited to, at least one type of storage medium among memories, such as a flash memory type, a hard disk type, a micro type, and a card type (e.g., a secure digital (SD) card or an eXtream digital (XD) card) and memories, such as a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The output unit 400 may be connected to the processor 100 to be controlled by the processor 100 and may output the result of the processor 100 determining whether the wheel bearing 30 is defective. Furthermore, when diagnosing a defect of the wheel bearing 30 for each wheel 20 of the vehicle 10, if the processor 100 determines that the sensor 200 has not moved from the first wheel 21 to the second wheel 22, the output unit 400 may output an alarm (see FIG. 10), to the operator, indicating that it is impossible to diagnose a defect of the wheel bearing of the second wheel 22.

The output unit 400 of various exemplary embodiments of the present disclosure may include, for example, a liquid crystal display (LCD) panel or an organic light emitting diode (OLED) panel, and may be a component included in a smart device, such as a smartphone or tablet of the operator, but is not limited thereto. The operator may recognize the result of determining a defect of the wheel bearing 30 for each wheel 20 of the vehicle 10 diagnosed through the output unit 400 and may recognize whether a defect diagnosis for each wheel 20 is omitted.

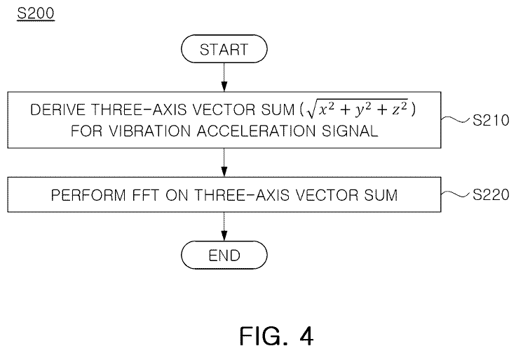

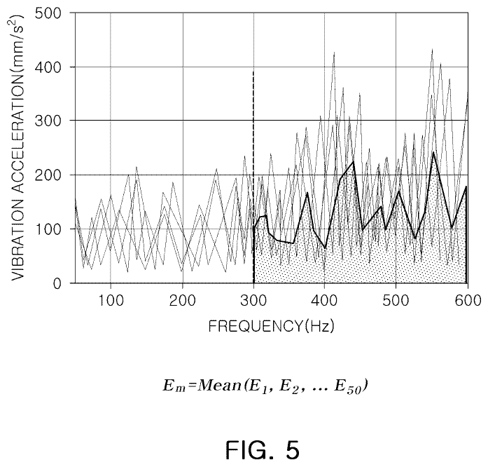

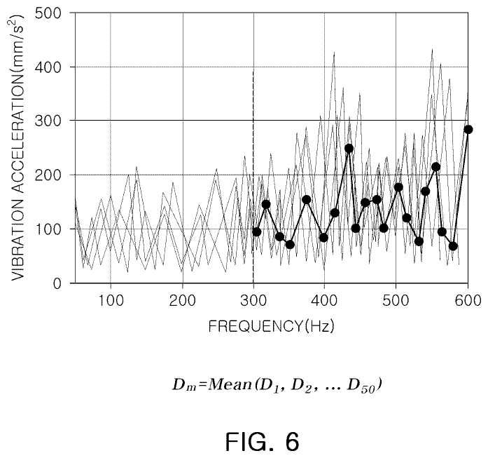

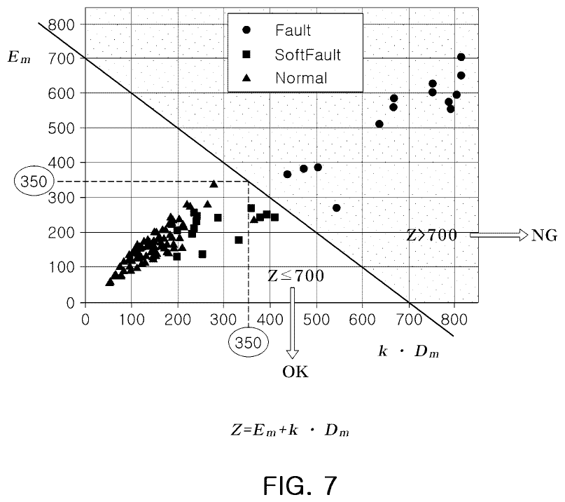

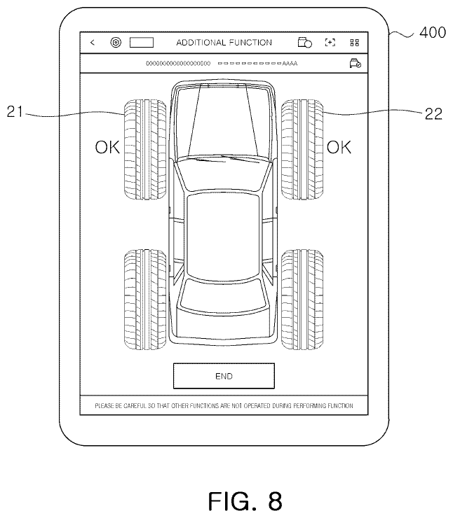

FIG. 3 is a flowchart of a wheel bearing defect diagnosis method according to an exemplary embodiment of the present disclosure, FIG. 4 is a flowchart illustrating detailed operations of preprocessing a vibration acceleration signal, FIG. 5 is a graph illustrating preprocessed vibration acceleration signals and a first parameter determined by integrating the same, FIG. 6 is a graph illustrating preprocessed vibration acceleration signals and a second parameter determined by differentiating the same, FIG. 7 is a graph illustrating a result of determining whether a wheel bearing is defective using a reference parameter, and FIG. 8 is a schematic diagram schematically illustrating an output unit outputting a defect determination result.

Referring to FIG. 2, FIG. 3 and FIG. 4, first, a method for diagnosing a defect of a wheel bearing according to various exemplary embodiments of the present disclosure may include an operation in which the processor 100 obtains a vibration acceleration signal through the sensor 200 mounted on the vehicle wheel 20 including the wheel bearing 30 as a target of defect diagnosis (S100). The sensor 200 may be mounted on the axle of the wheel 20 including the wheel bearing 30 to be defect diagnosed and may be a detachable component. When the vehicle 10 mounted on the lift is driven and the wheels 20 of the vehicle rotate, the processor 100 may obtain a vibration acceleration signal through the sensor 200 mounted on the wheel 20. Here, the obtained vibration acceleration signal may be a vibration acceleration signal of each of the three axes (X-axis, Y-axis, and Z-axis) of the forward/backward, left/right, and up/down directions.

Next, the method for diagnosing a defect of a wheel bearing according to various exemplary embodiments of the present disclosure may include an operation in which the processor preprocesses the vibration acceleration signal obtained from the sensor 200 (S200).

The operation of preprocessing the vibration acceleration signal (S200) may include an operation in which the processor determines a three-axis vector sum (\sqrt{x²+y²+z²}) from the individual vibration acceleration signals of each of the three axes (X-axis, Y-axis, and Z-axis) obtained from the sensor 200 (S210). In the present manner, by unifying the individual vibration acceleration signals of each of the three axes (X-axis, Y-axis, and Z-axis) into the three-axis vector sum (\sqrt{x²+y²+z²}), data errors according to the angle at which the sensor 200 is attached to the wheel 20 may be minimized.

Next, the method for diagnosing a defect of a wheel bearing according to various exemplary embodiments of the present disclosure may include an operation in which the processor 100 performs a Fast Fourier Transform (FFT) on the three-axis vector sum (S220). Here, the Fast Fourier Transform (FFT) is a mathematical transformation that converts a signal measured in a time domain into a frequency domain and may separate and analyze various frequency components included in the vibration signal, and may obtain data necessary for diagnosing a condition of the part to be measured and determining whether the part is defective through a magnitude and phase of each frequency component.

Next, the method for diagnosing a defect of a wheel bearing according to various exemplary embodiments of the present disclosure may include an operation in which the processor 100 determines the first parameter Em and the second parameter Dm from the preprocessed vibration acceleration signal (S300).

Referring to FIGS. 3 and 5, the first parameter Em of various exemplary embodiments of the present disclosure may be defined as an average of vibration energy determined by integrating the preprocessed vibration acceleration signal in a preset frequency band. Here, the preset frequency band may correspond to a range of 300 Hz to 600 Hz, but is not limited thereto, and may correspond to a range of 300 Hz to 800 Hz. Referring to FIG. 5, in a graph obtained by overlapping preprocessed vibration acceleration signals in a certain time range a certain number of times, an average value of vibration energy E₁, E₂, . . . , Eₙ obtained by integrating in the frequency domain in a certain frequency band may be defined as the first parameter Em. As an exemplary embodiment of the present disclosure, the graph may correspond to a graph visualized by overlapping 50 measurement results for 4 seconds, but is not limited thereto.

The second parameter Dm of various exemplary embodiments of the present disclosure may be defined as an average of amplitude variations determined by differentiating the preprocessed vibration acceleration signals in a preset frequency band. Here, the preset frequency band may correspond to a range of 300 Hz to 600 Hz, but is not limited thereto, and may correspond to a range of 300 Hz to 800 Hz. Referring to FIG. 6, in a graph obtained by overlapping preprocessed vibration acceleration signals in a certain time range a certain number of times, an average value of amplitude change amounts D₁, D₂, . . . , Dₙ obtained by differentiating in the frequency domain in a certain frequency band may be defined as the second parameter Dm. As an exemplary embodiment of the present disclosure, the graph may correspond to a graph visualized by overlapping 50 measurement results for 4 seconds, but is not limited thereto.

In an exemplary embodiment of the present disclosure, the operation of determining the first parameter Em and the second parameter Dm may include an operation in which the processor 100 determines the first parameter Em and the second parameter Dm by performing at least one of differentiation and integration on the preprocessed vibration acceleration signals in a preset frequency band.

Next, the method for diagnosing a defect of a wheel bearing according to various exemplary embodiments of the present disclosure may include an operation in which the processor 100 obtains the reference parameter Z from the determined first parameter Em and second parameter Dm (S400). The reference parameter Z may be defined by Equation 1 below including the first parameter Em and the second parameter Dm.

$$Z = Em + k * Dm \qquad [ Mathematical formula 1 ]$$

That is, in the method for diagnosing a defect of a wheel bearing according to an exemplary embodiment of the present disclosure, the reference parameter Z may be defined as the sum of the first parameter Em and constant (k) times of the second parameter Dm. Here, k may correspond to a constant arbitrarily set to match the scale between the first parameter Em and the second parameter Dm. Such a reference parameter Z may function as an index for determining whether the wheel bearing 30 is defective based on the vibration acceleration signal.

Next, the method for diagnosing a defect of a wheel bearing according to various exemplary embodiments of the present disclosure may include an operation in which the processor 100 compares the reference parameter Z with a preset upper limit value (S500), determines that the wheel bearing 30 is defective if the reference parameter Z exceeds the upper limit value (S520), and determines that the wheel bearing 30 is normal if the reference parameter Z is equal to or lower than the upper limit value (S510).

Here, the first parameter Em of the wheel bearing 30 determined as being defective may include a value greater than the first parameter Em of the wheel bearing 30 determined as being normal. Since the defective wheel bearing 30 generates greater vibration energy than the normal wheel bearing 30, the first parameter Em corresponding to the average of the vibration energy determined by integrating the vibration acceleration signals in the preset frequency band may be measured to be greater for the defective wheel bearing 30 than for the normal wheel bearing 30.

Furthermore, the second parameter Dm of the wheel bearing 30 determined to be defective may include a greater value than the second parameter Dm of the wheel bearing 30 determined as being normal. Since the vibration amplitude of the defective wheel bearing 30 is not constant compared to the normal wheel bearing 30 and the amplitude variation occurs significantly, the second parameter Dm corresponding to the average of the amplitude variations determined by differentiating the vibration acceleration signals in a preset frequency band may be measured to be greater for the defective wheel bearing 30 than for the normal wheel bearing 30.

Since the first parameter Em of the defective wheel bearing 30 is measured to be greater than the first parameter Em of the normal wheel bearing 30 and the second parameter Dm of the defective wheel bearing 30 is measured to be greater than the second parameter Dm of the normal wheel bearing 30, whether the wheel bearing 30 is defective may be determined based on whether the reference parameter Z corresponding to the sum of the first parameter Em and the second parameter multiplied by a constant Dm exceeds a preset upper limit value.

Here, the preset upper limit value may be 700, but is not limited thereto, and may be set by a user according to a vehicle type or measurement environment.

Referring to FIGS. 3 and 7, for example, when the preset upper limit value is 700 and a graph satisfying a mathematical formula, such as Em+k*Dm=700 is set on a plane in which the horizontal axis is a constant (k) times of the second parameter Dm and the vertical axis is the first parameter Em, the graph may be divided into a region in which the reference parameter Z is 700 or less and a region in which the reference parameter Z exceeds 700. Here, the region in which the reference parameter Z is 700 or less may be determined as a normal range of the wheel bearing 30, and the region in which the reference parameter Z exceeds 700 may be determined as a defect range of the wheel bearing 30.

Meanwhile, in FIG. 7, data obtained by actually checking whether a wheel bearing is defective and the degree of the defect caused by wear, damage, corrosion, contamination, and the like of the wheel bearing are displayed together on the graph. It may be seen that normal and soft fault data included in the normal range and fault data corresponding to a defect range are accurately classified by comparing the reference parameter Z with the upper limit value. The classification between soft fault and fault states may be a part in which the subjectivity of the operator is easily involved, but in the case of the method for diagnosing a defect of a wheel bearing according to an exemplary embodiment of the present disclosure is performed, the soft fault and fault states may be objectively and accurately classified.

Next, the method for diagnosing a defect of a wheel bearing according to various exemplary embodiments of the present disclosure may further include an operation in which the processor 100 outputs the result of determining whether the wheel bearing 30 is defective through the output unit 400 (S600). The output unit 400 may be a component included in a smart device, such as an operator's smartphone or tablet, and may include a component configured for communicating with the sensor 200 or a server, but is not limited thereto.

Referring to FIG. 8, the output unit 400 may display each of the wheels 21 and 22 of the vehicle as a target of wheel bearing defect diagnosis, and for example, when the wheel bearing is determined to be within a normal range by the processor 100, “OK” indicating that each of the wheels 21 and 22 is normal may be output. Meanwhile, although not shown, if the wheel bearing is determined to be within a defect range by the processor 100, “NG” indicating that each of the wheels 21 and 22 is defective may be output. Furthermore, the first wheel 21 may be determined to be normal and the second wheel 22 may be determined to be defective, or vice versa.

Meanwhile, the operations (S100 to S600) of the method for diagnosing a defect of a wheel bearing according to an exemplary embodiment of the present disclosure may be sequentially repeated for each wheel 20 of the vehicle 10.

FIG. 9 is a graph illustrating a vibration acceleration signal when a sensor mounted on a first wheel is moved to be mounted on a second wheel, and FIG. 10 is a graph illustrating an example of a defect diagnosis failure alarm output to an output unit when a diagnosis omission is detected.

Referring to FIG. 1, FIG. 8, FIG. 9 and FIG. 10, the wheel 20 of the vehicle 10 may include the first wheel 21 and the second wheel 22, and the wheel bearing 30 may include the first wheel bearing 31 provided on the first wheel 21 and the second wheel bearing 32 provided on the second wheel 22.

For example, when the sensor 200 is removed from the first wheel 21 after diagnosing whether the first wheel bearing 31 is defective and the sensor 200 is attached to the second wheel 22 to diagnose whether the second wheel bearing 32 is defective, the processor 100 may be configured for controlling the sensor 200 to measure a time T required from a point in time at which whether the first wheel bearing 31 is defective to a point in time at which a vibration acceleration signal of the second wheel 22 is obtained, and a vibration peak occurring within the range of the required time T.

Referring to FIG. 9 and FIG. 10, in the method for diagnosing a defect of a wheel bearing according to an exemplary embodiment of the present disclosure, if at least one condition, among a case in which the time T required from the point in time at which whether the first wheel bearing 31 is defective is determined to the point in time at which the vibration acceleration signal of the second wheel 22 is obtained as a result of the measurement of the sensor 200 is detected to be less than a preset time (e.g., 5 seconds) and a case in which the number of times a low-frequency band peak occurs as a result of measuring the vibration peak occurring within the range of the required time T is detected to be less than a preset number of times (e.g., 2 times), is satisfied, the processor 100 may output an alarm indicating that it is impossible to diagnose a defect of the second wheel bearing 32 through the output unit 400.

Meanwhile, if both the condition in which the time T required from the point in time at which whether the first wheel bearing 31 is defective to the point in time at which the vibration acceleration signal of the second wheel 22 is obtained is detected to be greater than or equal to the preset time (e.g., 5 seconds) as a result of the measurement of the sensor 200 and the condition in which the number of times the low-frequency band peaks occur within the range of the required time T is detected to be greater than a preset number of times (e.g., 2 times) are satisfied, the processor 100 may sequentially perform each operation of FIG. 3 to diagnose a defect of the second wheel bearing 32.

Here, the preset time may be any time required to remove the sensor 200 from the first wheel 21 and move the sensor 200 to the second wheel 22 and mount the sensor 200 on the second wheel 22, and may be set to 5 seconds as an exemplary embodiment of the present disclosure, but is not limited thereto.

Furthermore, the preset number of times may correspond to the sum of the number of low-frequency band peaks that occur when the sensor 200 is removed from the first wheel 21 and the number of low-frequency band peaks that occur when the sensor 200 is moved to be mounted on the second wheel 22, and may be set to 2 times as an exemplary embodiment of the present disclosure, but is not limited thereto.

The method for diagnosing a defect of a wheel bearing according to an exemplary embodiment of the present disclosure may prevent the risk of occurrence of incorrect maintenance, such as omission of defect diagnosis for each wheel 20 or repeated measurement of vibration acceleration signals only for one wheel 20, through the algorithm described above.

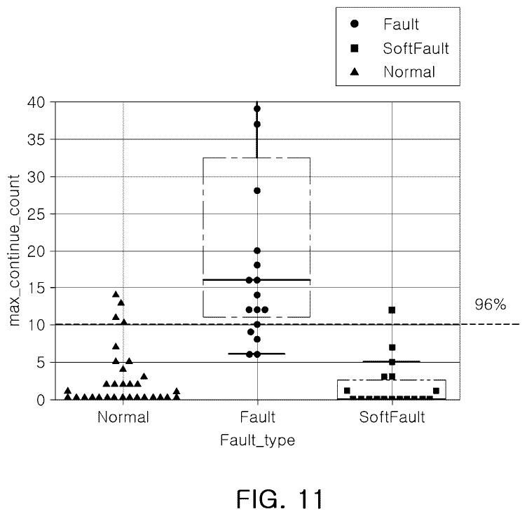

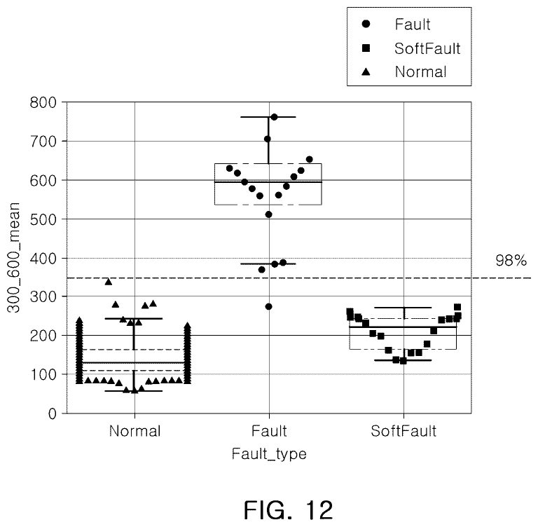

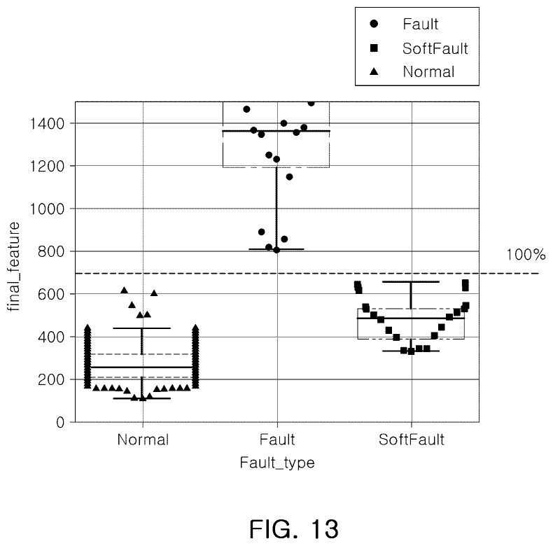

FIG. 11 is a graph of results when determining whether a wheel bearing is defective using only the number of times a vibration acceleration exceeds a threshold value, FIG. 12 is a graph of results when determining whether a wheel bearing is defective using only the first parameter, and FIG. 13 is a graph of results when determining whether a wheel bearing is defective using first and second parameters according to a wheel bearing defect diagnosis method according to an exemplary embodiment of the present disclosure.

In FIG. 11, FIG. 12 and FIG. 13, Normal, Soft Fault, and Fault represent the actually confirmed states of wheel bearings, and the Normal and Soft Fault states are included in the normal range, while the Fault state corresponds to the defect range.

FIG. 11 illustrates a result of determination by a method of determining a defect when a case in which a vibration acceleration signal measured from a vehicle wheel exceeds a certain threshold value of 280 m/s² is measured continuously 10 or more times. In the case of the present method, some errors occurred, such as determining wheel bearings in the normal range as being defective, and a final determination accuracy was 96%.

FIG. 12 illustrates a result of determination by a method of determining a defect when the first parameter Em obtained through the integration of the preprocessed vibration acceleration signals exceeds the upper limit value of 350 based only on the first parameter Em. Even in the present method, some errors occurred, such as determining wheel bearings in the normal range as being defective, and a final determination accuracy was 98%.

FIG. 13 illustrates a result of determination by a method of determining a defect when the reference parameter Z determined through the first parameter Em and the second parameter Dm exceeds the preset upper limit value of 700 according to the method for diagnosing a defect of a wheel bearing according to an exemplary embodiment of the present disclosure. In the case of the present method, wheel bearings in the Normal and Soft Fault states are determined as being normal and wheel bearings in the Fault state are determined as being defective, and thus, a final determination accuracy was 100%.

According to an aspect of the present disclosure, whether a wheel bearing for a vehicle is defective may be objectively and accurately determined.

According to another aspect of the present disclosure, whether each of the wheel bearings respectively mounted on the vehicles of a vehicle is defective may be diagnosed without omission.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for diagnosing a defect of a wheel bearing, the method comprising:
obtaining, by a processor, a vibration acceleration signal of a wheel of a vehicle including the wheel bearing;
preprocessing, by the processor, the vibration acceleration signal;
determining, by the processor, a first parameter and a second parameter from the preprocessed vibration acceleration signal;
obtaining, by the processor, a reference parameter from the first parameter and the second parameter; and
comparing, by the processor, the reference parameter with a preset upper limit value, determining, by the processor, that the wheel bearing is defective in response that the reference parameter exceeds the upper limit value, and determining, by the processor, that the wheel bearing is normal in response that the reference parameter is equal to or less than the upper limit value.

2. The method of claim 1, further including outputting a result of the determining.

3. The method of claim 1, wherein the first parameter is an average of vibration energy determined by integrating the vibration acceleration signal in a preset frequency band.

4. The method of claim 3, wherein the second parameter is an average of amplitude variations determined by differentiating the vibration acceleration signal in the preset frequency band.

5. The method of claim 4, wherein the reference parameter is a sum of the first parameter and the second parameter multiplied by a constant.

6. The method of claim 4, wherein, in the determining of the wheel bearing as being defective or normal, the first parameter of the wheel bearing determined as being defective is greater than the first parameter of the wheel bearing determined as being normal.

7. The method of claim 4, wherein, in the determining of the wheel bearing as being defective or normal, the second parameter of the wheel bearing determined as being defective is greater than the second parameter of the wheel bearing determined as being normal.

8. The method of claim 1, wherein the determining of the first parameter and the second parameter includes determining the first parameter and the second parameter by performing at least one of differentiation and integration on the preprocessed vibration acceleration signal in a preset frequency band.

9. The method of claim 1, wherein the preprocessing of the vibration acceleration signal includes:
determining a three-axis (X, Y, Z) vector sum for the vibration acceleration signal; and
performing a Fast Fourier Transform on the three-axis vector sum.

10. The method of claim 1, wherein, in the obtaining of the vibration acceleration signal of the wheel of the vehicle, in response that the vehicle mounted on a lift is driven and the wheel of the vehicle rotates, the vibration acceleration signal is obtained through a sensor mounted on the wheel and connected to the processor.

11. The method of claim 10, wherein the sensor is detachably mounted on an axle of the wheel.

12. The method of claim 10, wherein each of the operations is performed sequentially for each wheel of the vehicle.

13. The method of claim 12,
wherein the wheel of the vehicle includes a first wheel and a second wheel,
wherein the wheel bearing includes a first wheel bearing mounted on the first wheel and a second wheel bearing mounted on the second wheel, and
wherein the sensor measures a time required from a point in time at which whether the first wheel bearing is defective is determined to a point in time at which a vibration acceleration signal of the second wheel is obtained, and a vibration peak occurring within the required time period.

14. The method of claim 13, further including:
in response that the required time is less than a preset time or in response that a number of times a low-frequency band peak occurs as a result of measuring the vibration peak is less than a preset number of times, outputting an alarm indicating that diagnosing a defect of the second wheel is impossible.

15. The method of claim 13, wherein, in response that the required time is greater than the preset time and the number of times the low-frequency band peak occurs as a result of measuring the vibration peak is greater than or equal to a preset number of times, each operation for diagnosing a defect of the second wheel bearing is performed sequentially.

16. A system for diagnosing a defect of a wheel bearing, the system comprising:
a sensor detachably mounted on an axle of a wheel including a wheel bearing;
a processor operatively connected to the sensor;
an output unit operatively connected to the processor; and
a memory connected to the processor and storing command and data,
wherein by executing the command stored in the memory, the processor is configured to obtain a vibration acceleration signal of the wheel of a vehicle measured by the sensor, preprocess the vibration acceleration signal, determine a first parameter and a second parameter from the preprocessed vibration acceleration signal, obtain a reference parameter from the first parameter and the second parameter, compare the reference parameter with a preset upper limit value, determine that the wheel bearing is defective in response that the reference parameter exceeds the upper limit value, determine that the wheel bearing is normal in response that the reference parameter is equal to or less than the upper limit value, and output a result of the determining through the output unit.

17. The system of claim 16, wherein the first parameter is an average of vibration energy determined by integrating the vibration acceleration signal in a preset frequency band, the second parameter is an average of amplitude variations determined by differentiating the vibration acceleration signal in the preset frequency band, and the reference parameter is a sum of the first parameter and the second parameter multiplied by a constant.

18. The system of claim 16,
wherein the wheel of the vehicle includes a first wheel and a second wheel,
wherein the wheel bearing includes a first wheel bearing mounted on the first wheel and a second wheel bearing mounted on the second wheel, and
wherein the sensor measures a time required from a point in time at which whether the first wheel bearing is defective is determined to a point in time at which a vibration acceleration signal of the second wheel is obtained, and a vibration peak occurring within the required time period.

19. The system of claim 18, wherein, in response that the required time is less than a preset time or in response that a number of times a low-frequency band peak occurs as a result of measuring the vibration peak is less than a preset number of times, the processor is further configured to output an alarm indicating that diagnosing a defect of the second wheel through the output unit is impossible.

20. The system of claim 18, wherein, in response that the required time is greater than the preset time and the number of times the low-frequency band peak occurs as a result of measuring the vibration peak is greater than or equal to a preset number of times, the processor is further configured to determine whether the second wheel bearing is defective.
